(19) United States
(12) Patent Application Publication
(10) Pub. No.: US 2025/0032862 A1
(43) Pub. Date: Jan. 30, 2025

(54) PORTABLE GOLF BALL CLEANING DEVICE

(71) Applicant: Allomin Co., Ltd., Seoul (KR)

(72) Inventor: Dong Hyeok KIM, Yongin-si (KR)

(73) Assignee: Allomin Co., Ltd., Seoul (KR)

(21) Appl. No.: 18/780,791

(22) Filed: Jul. 23, 2024

(30) Foreign Application Priority Data
Jul. 27, 2023 (KR) 10-2023-0098518

(51) Int. Cl. A63B 47/04; A46B 5/06; A63B 102/32; B08B 1/12; B08B 1/20

(52) U.S. Cl. CPC A63B 47/04; A46B 5/06; B08B 1/12; B08B 1/20; A46B 2200/3073; A63B 2102/32

(57) ABSTRACT

A portable golf ball cleaning device, includes: a housing having a cleaning member; a golf ball reciprocating member for receiving and reciprocating a golf ball to allow dirt attached to the surface of the golf ball to be removed using the cleaning member; and a backflow prevention filter for defining an internal space portion formed on an underside of the housing, having a through hole formed on a central portion thereof in such a way as to pass the dirt therethrough, and preventing the dirt collected in the internal space portion from moving back to the housing.

### CROSS REFERENCE TO PRIOR APPLICATIONS

The present application claims the benefit of Korean Patent Application No. 10-2023-0098518 filed in the Korean Intellectual Property Office on Jul. 27, 2023, the entire contents of which are incorporated herein by reference.

### SUMMARY

The present disclosure relates to a portable golf ball cleaning device.

If a golf ball to which dirt such as soil, dust, grass, and the like is attached is hit with a golf club, it is hard that the golf ball flies to a golfer's desired position. Therefore, it is good that the golf ball covered with the dirt is used after cleaned.

There is no inconvenience in playing golf in a golf course having caddies because golf balls are cleaned by the caddies, but in a golf course having no caddies, the golf ball is cleaned by a golfer himself or herself. In this case, therefore, it is necessary that the golfer carries a portable golf ball cleaning device with him or her.

If the golf ball cleaning device is consistently used for long hours, however, a large amount of dirt is collected therein, and if the golf ball is cleaned in such a state, the dirt collected in the golf ball cleaning device is entangledly mixed so that the golf ball is not cleaned well.

If it is desired to remove the dirt from the cleaning device, further, the cleaning device turns over to discharge the dirt to the outside, but in this case, it is hard to easily remove the dirt from the cleaning device due to cleaning brushes located in the cleaning device.

### PRIOR ART LITERATURE

[Patent literature 1] U.S. Patent Application No. 2019-0308078 A1 (Dated on Oct. 10, 2019)

### SUMMARY

Accordingly, the present disclosure has been made in view of the above-mentioned problems occurring in the related art, and it is an object of the present disclosure to provide a portable golf ball cleaning device that is capable of cleaning a golf ball well even if a given amount of dirt is collected therein and capable of easily removing the dirt collected therein.

To accomplish the above-mentioned objects, according to one aspect of the present disclosure, there is provided a portable golf ball cleaning device including: a housing having a cleaning member; a golf ball reciprocating member for receiving and reciprocating a golf ball to allow dirt attached to the golf ball to be removed by means of the cleaning member; and a backflow prevention filter for defining an internal space portion formed on an underside of the housing, having a through hole formed on a central portion thereof in such a way as to pass the dirt therethrough, and preventing the dirt collected in the internal space portion from moving back to the housing.

According to the present disclosure, desirably, the internal space portion may be open to remove the dirt collected therein.

According to the present disclosure, desirably, the backflow prevention filter may be slant downward from a peripheral portion thereof toward a central portion thereof.

According to the present disclosure, desirably, the internal space portion may have a bottom convex upward from the central portion thereof.

According to the present disclosure, desirably, the internal space portion may have a height of the central portion thereof lower than a height of the peripheral portion thereof.

According to the present disclosure, desirably, the cleaning member may include a first brush and a second brush detachably attached to the housing in such a way as to come into contact with the inner peripheral wall of the housing and be thus inserted into the housing.

According to the present disclosure, desirably, the first and second cleaning brushes each may include a core member made of a flexible material and having a plurality of grooves in a longitudinal direction thereof and a plurality of bristles protruding outward from the core member.

To accomplish the above-mentioned objects, according to another aspect of the present disclosure, there is provided a portable golf ball cleaning device including: a housing open on a top and underside thereof to form a top opening and an underside opening and a cleaning member located at the inside thereof; a golf ball reciprocating member having a handle, a top cap coupled to the handle, and a golf ball seating stand coupled to the top cap in such a way as to receive a golf ball; and a bottom cap member detachably coupled to a lower portion of the housing, while being open on a top thereof and closed on an underside thereof to form an internal space portion therein.

According to the present disclosure, desirably, if the handle moves up and down in a state where the golf ball is seated onto the golf ball seating stand, the golf ball may be cleaned by means of the cleaning member, and if dirt attached to the golf ball moves down to the internal space portion, the bottom cap member may be separated from the housing to remove the dirt from the internal space portion.

According to the present disclosure, desirably, the cleaning device may further include an auxiliary cap member located on the underside opening of the housing to form the internal space portion, together with the bottom cap member, the auxiliary cap member having a through hole formed on a central portion thereof in such a way as to pass the dirt therethrough.

According to the present disclosure, desirably, the auxiliary cap member may be slant downward from a peripheral portion thereof toward a central portion thereof.

According to the present disclosure, desirably, the bottom cap member may have a bottom convex upward from the central portion thereof.

According to the present disclosure, desirably, the internal space portion may have a height of the central portion thereof lower than a height of the peripheral portion thereof.

According to the present disclosure, desirably, the cleaning member may include a first cleaning brush and a second cleaning brush detachably attached to the housing in such a way as to come into contact with the inner peripheral wall of the housing and be thus inserted into the housing.

According to the present disclosure, desirably, the first and second cleaning brushes each may include a core member made of a flexible material and having a plurality of grooves in a longitudinal direction thereof and a plurality of bristles protruding from the core member.

According to the present disclosure, desirably, the housing may have a stepped projection protruding inward from the inner peripheral wall thereof at the inside of the underside opening thereof and a first fitting member and a second fitting member extending from the inner peripheral wall of the top opening of the housing to the stepped projection in upward and downward directions in such a way as to face each other.

According to the present disclosure, desirably, the first fitting member may include a first slide bar and a second slide bar spaced apart from each other, the first slide bar having a first vertical bar protruding vertically from the inner peripheral wall of the housing and a first hook made by bending the end of the first vertical bar to an angle of 90°, and the second slide bar having a second vertical bar protruding vertically from the inner peripheral wall of the housing and a second hook made by bending the end of the first vertical bar to an angle of 90° in the opposite direction to the first hook, and the second fitting member may include a third slide bar and a fourth slide bar spaced apart from each other, the third slide bar having a third vertical bar protruding vertically from the inner peripheral wall of the housing and a third hook made by bending the end of the third vertical bar to an angle of 90°, and the fourth slide bar having a fourth vertical bar protruding vertically from the inner peripheral wall of the housing and a fourth hook made by bending the end of the fourth vertical bar to an angle of 90° in the opposite direction to the third hook.

According to the present disclosure, desirably, the cleaning member may include a first cleaning brush to come into contact with the inner peripheral wall of the housing in such a way as to be detachably fitted between the first slide bar and the third slide bar in upward and downward directions, and a second cleaning brush to come into contact with the inner peripheral wall of the housing in such a way as to be detachably fitted between the second slide bar and the fourth slide bar in upward and downward directions.

According to the present disclosure, desirably, the cleaning device may further include an auxiliary coupling member coupled to the housing and having a locking projection and first protrusions, wherein the golf ball reciprocating member may have rotation and coupling grooves formed on the top cap in such a way as to be coupled to the first protrusions so that the golf ball reciprocating member is coupled to the auxiliary coupling member, and the golf ball seating stand may have second protrusions protruding outward from both ends of a lower portion thereof in such a way as to be locked onto the locking projection so that the golf ball seating stand is prevented from escaping from the auxiliary coupling member.

### BRIEF DESCRIPTION OF THE DRAWINGS

The above and other objects, features and advantages of the present disclosure will be apparent from the following detailed description of the embodiments of the disclosure in conjunction with the accompanying drawings.

FIG. 1 is a perspective view showing a portable golf ball cleaning device according to the present disclosure.

FIGS. 2 and 3 are exploded perspective views showing the portable golf ball cleaning device according to the present disclosure that is seen on top and bottom thereof.

FIGS. 4 and 5 are sectional views showing the portable golf ball cleaning device according to the present disclosure.

FIGS. 6 and 7 are perspective views showing the portable golf ball cleaning device according to the present disclosure from which a housing is separated.

FIG. 8 is a perspective view showing a state where the golf ball is inserted into the housing according to upward and downward movements of a handle in the portable golf ball cleaning device according to the present disclosure.

FIGS. 9 and 10 are perspective views showing a state where a cleaning brush is inserted into the housing of the portable golf ball cleaning device according to the present disclosure.

FIG. 11 is a perspective view showing the cleaning brush of the portable golf ball cleaning device according to the present disclosure.

FIGS. 12 and 13 are perspective views showing an auxiliary coupling member of the portable golf ball cleaning device according to the present disclosure.

FIG. 14 is a perspective view showing the housing and an auxiliary cap member of the portable golf ball cleaning device according to the present disclosure.

FIG. 15 is a side view showing the auxiliary cap member of the portable golf ball cleaning device according to the present disclosure.

FIG. 16 is a perspective view showing the auxiliary cap member of the portable golf ball cleaning device according to the present disclosure that is seen on top thereof.

FIG. 17 is a perspective view showing the internal space of the portable golf ball cleaning device according to the present disclosure that is seen through a top opening of the housing.

FIG. 18 is a perspective view showing the internal space of the portable golf ball cleaning device according to the present disclosure that is seen through an underside opening of the housing.

### DETAILED DESCRIPTION

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology.

The present disclosure may be modified in various ways and may have several exemplary embodiments. Specific exemplary embodiments of the present disclosure are illustrated in the drawings and described in detail in the detailed description. However, this does not limit the disclosure within specific embodiments and it should be understood that the disclosure covers all the modifications, equivalents, and replacements within the idea and technical scope of the disclosure.

In the description, when it is said that one portion is described as “includes” any component, one element further may include other components unless no specific description is suggested.

Hereinafter, an explanation of a portable golf ball cleaning device according to an embodiment of the present disclosure will be given in detail with reference to the attached drawings to allow the embodiment of the present disclosure to be easily carried out by a person skilled in the art.

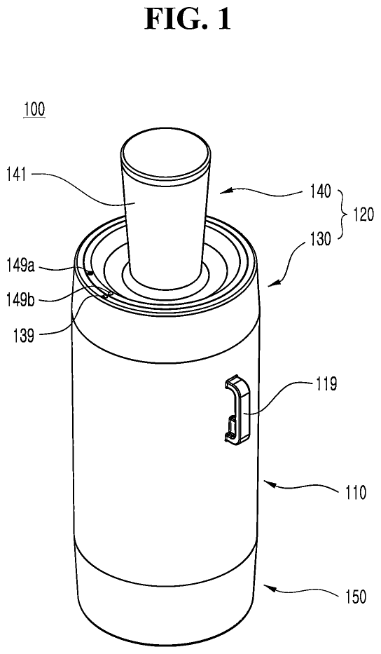

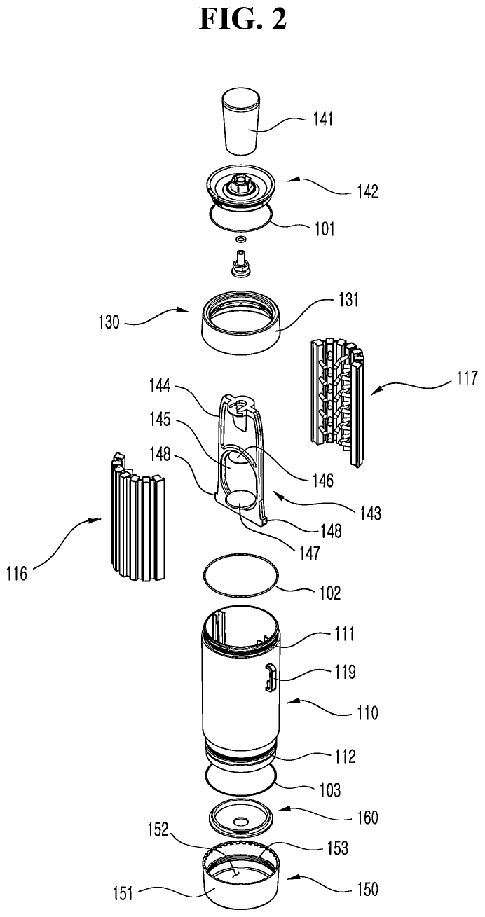

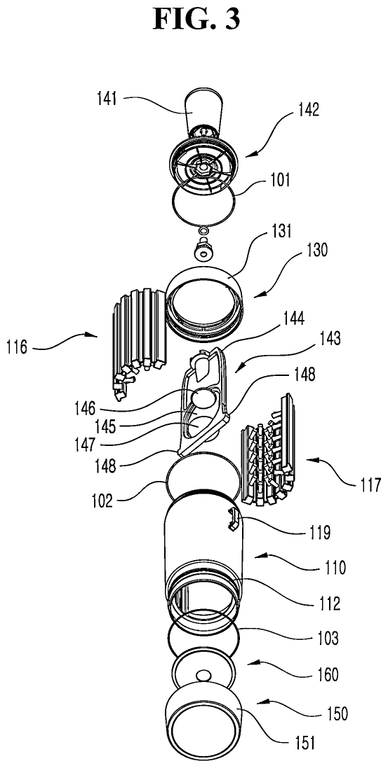

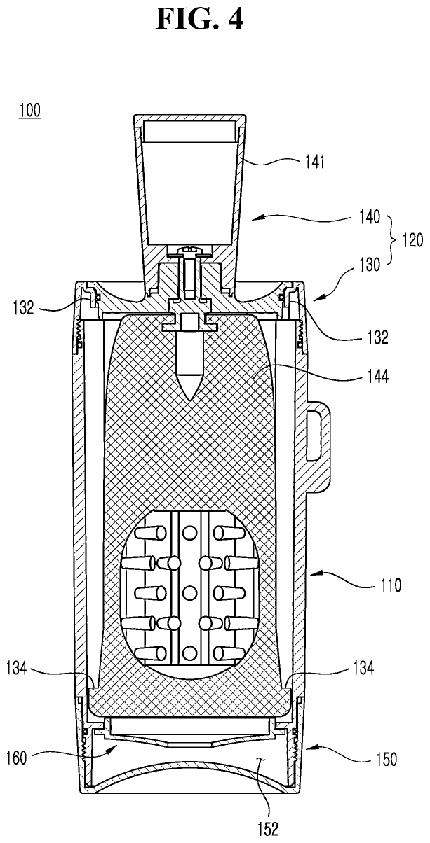

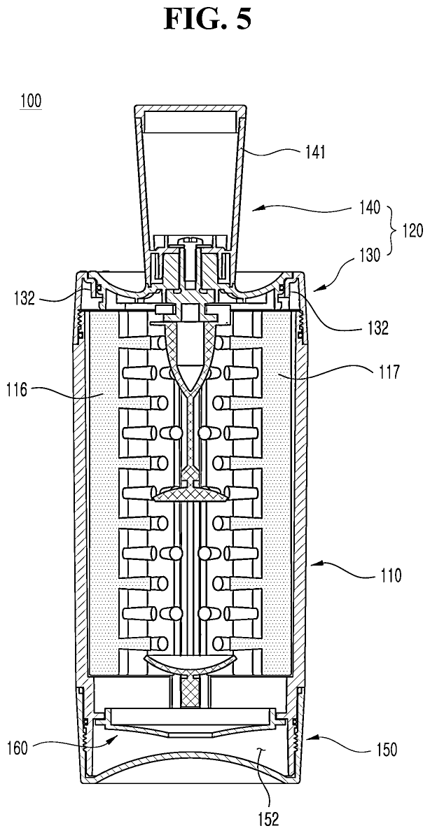

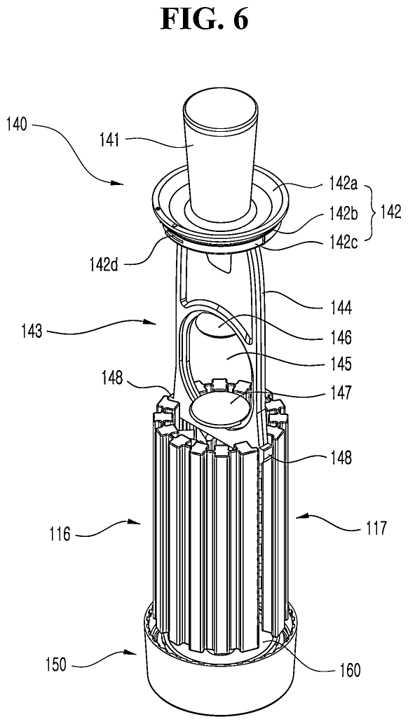

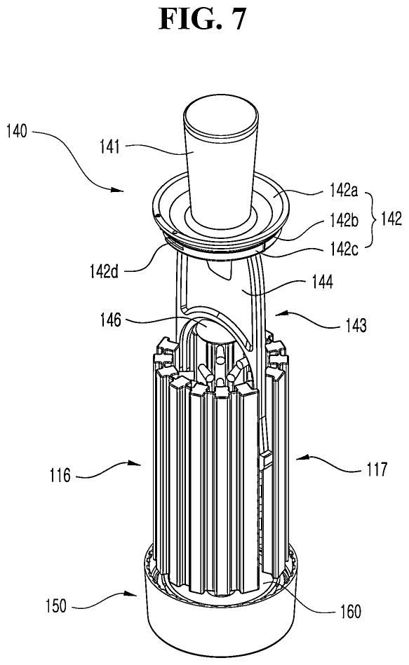

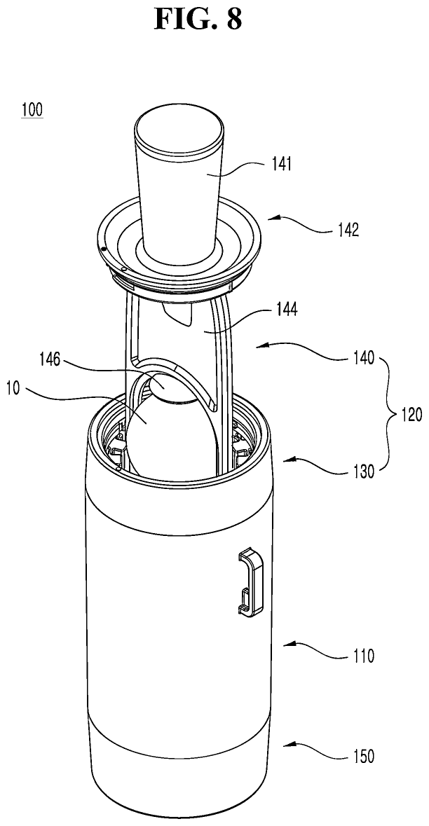

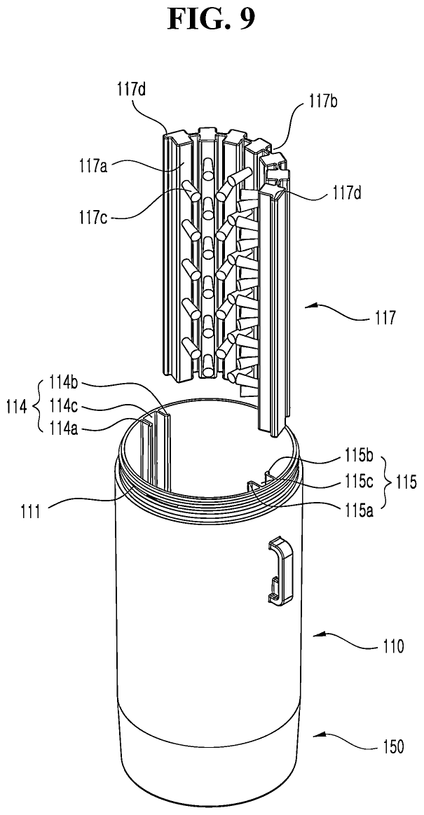

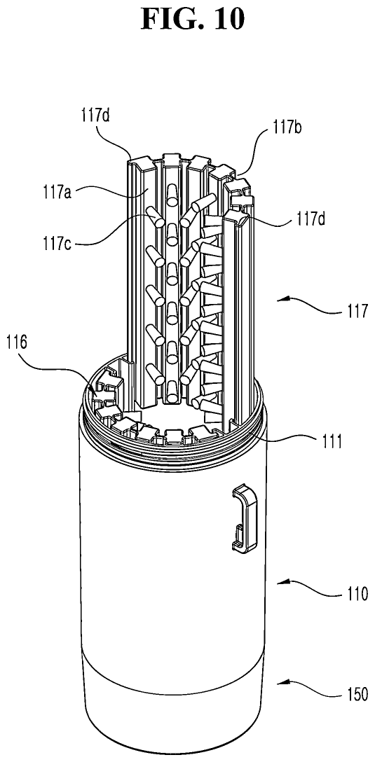

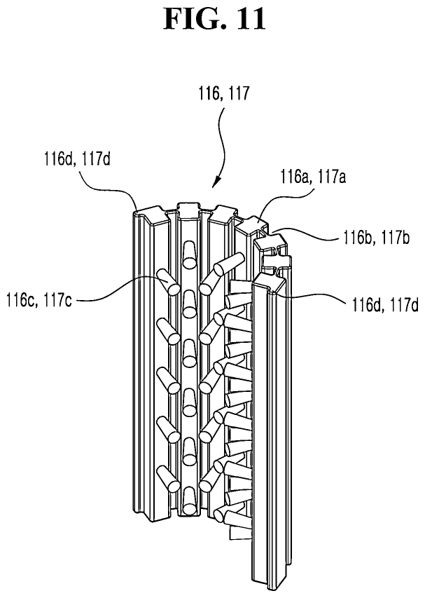

FIG. 1 is a perspective view showing a portable golf ball cleaning device according to the present disclosure, FIGS. 2 and 3 are exploded perspective views showing the portable golf ball cleaning device according to the present disclosure that is seen on top and bottom thereof, FIGS. 4 and 5 are sectional views showing the portable golf ball cleaning device according to the present disclosure, FIGS. 6 and 7 are perspective views showing the portable golf ball cleaning device according to the present disclosure from which a housing is separated, FIG. 8 is a perspective view showing a state where the golf ball is inserted into the housing according to upward and downward movements of a handle in the portable golf ball cleaning device according to the present disclosure, FIGS. 9 and 10 are perspective views showing a state where a cleaning brush is inserted into the housing of the portable golf ball cleaning device according to the present disclosure, and FIG. 11 is a perspective view showing the cleaning brush of the portable golf ball cleaning device according to the present disclosure.

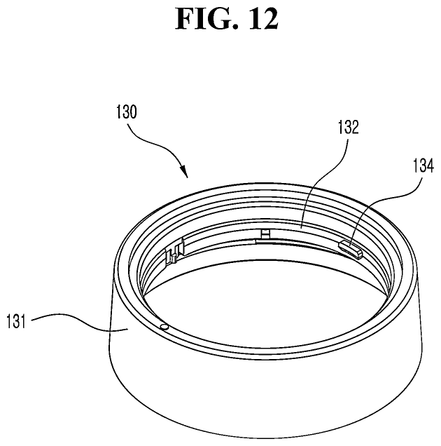

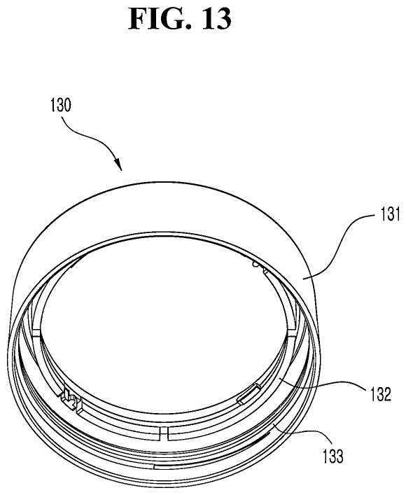

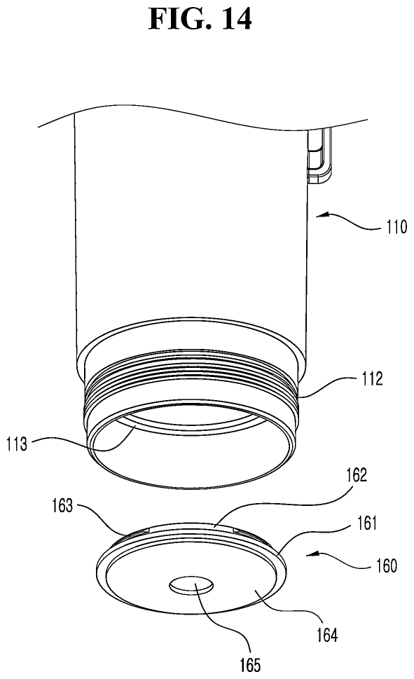

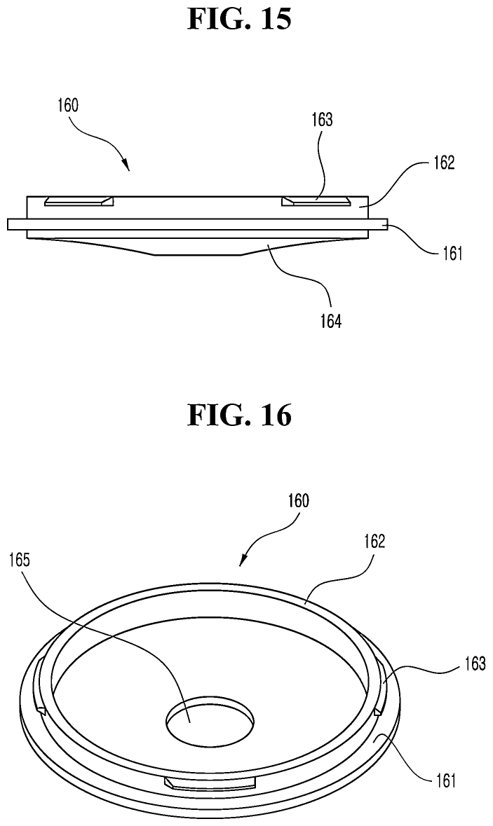

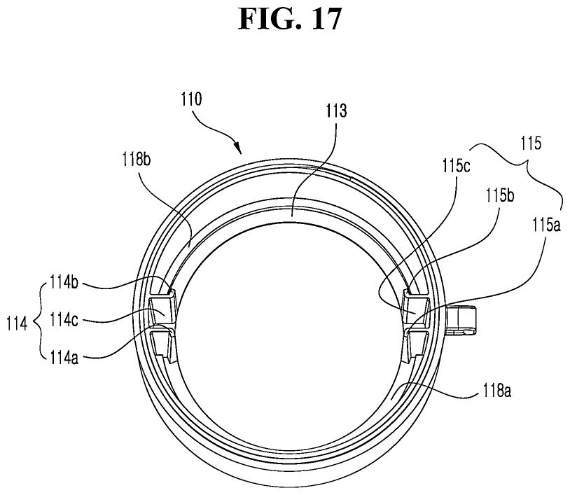

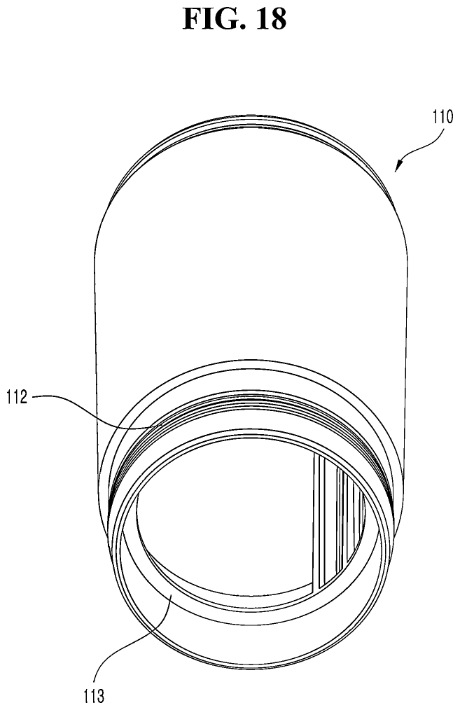

FIGS. 12 and 13 are perspective views showing an auxiliary coupling member of the portable golf ball cleaning device according to the present disclosure, FIG. 14 is a perspective view showing the housing and an auxiliary cap member of the portable golf ball cleaning device according to the present disclosure, FIG. 15 is a side view showing the auxiliary cap member of the portable golf ball cleaning device according to the present disclosure, FIG. 16 is a perspective view showing the auxiliary cap member of the portable golf ball cleaning device according to the present disclosure that is seen on top thereof, FIG. 17 is a perspective view showing the internal space of the portable golf ball cleaning device according to the present disclosure that is seen through a top opening of the housing, and FIG. 18 is a perspective view showing the internal space of the portable golf ball cleaning device according to the present disclosure that is seen through an underside opening of the housing.

As shown in FIGS. 1 to 5, a portable golf ball cleaning device 100 according to an embodiment of the present disclosure largely includes a housing 110, a golf ball seating member 120, and a bottom cap member 150.

The housing 110 is hollow at the inside thereof and has a given length so that it can be held by a user. In the drawings, the housing 110 is cylindrical, but it may not be limited thereto.

As shown in FIGS. 2 and 3, the housing 110 has a first screw groove 111 formed spirally on the outer peripheral surface of an upper end thereof and a second screw groove 112 formed spirally on the outer peripheral surface of a lower end thereof. Further, the housing 110 has a hanger 119 located on a given central portion of the outer peripheral surface thereof to hang goods with a loop or band, such as a cloth, a glove, and the like thereon.

Further, the housing 110 is hollow in upward and downward directions and thus open on top and underside thereof to form a top opening and an underside opening.

As shown in FIG. 18, the housing 110 has a circular stepped projection 113 with a given width that protrudes inward from the inner peripheral wall thereof at a given height of the inside of the underside opening thereof.

Further, fitting members are located to extend in upward and downward directions from the inner peripheral wall of the top opening of the housing 110 to the circular stepped projection 113.

As shown in FIG. 17, a first fitting member 114 and a second fitting member 115 are provided as the fitting members in such a way as to face each other on the inner peripheral wall of the housing 110.

The first fitting member 114 includes a first slide bar 114a and a second slide bar 114b extending in the upward and downward directions from the inner peripheral wall of the top opening of the housing 110 to the circular stepped projection 113, while having the horizontal sectional shape of ‘ [symbol] ’. The first slide bar 114a includes a first vertical bar protruding vertically from the inner peripheral wall of the housing 110 and a first hook made by bending the end of the first vertical bar to an angle of 90°, and the second slide bar 114b includes a second vertical bar protruding vertically from the inner peripheral wall of the housing 110 in such a way as to be spaced apart from the first vertical bar by a given distance and a second hook made by bending the end of the second vertical bar to an angle of 90° in the opposite direction to the first hook.

The first slide bar 114a and the second slide bar 114b are spaced apart from each other by the given distance, and accordingly, the space between the first slide bar 114a and the second slide bar 114b forms a first slide groove 114c in a longitudinal direction of the housing 110.

The second fitting member 115 includes a third slide bar 115a and a fourth slide bar 115b extending in the upward and downward direction from the inner peripheral wall of the top opening of the housing 110 to the circular stepped projection 113, while having the horizontal sectional shape of ‘ [symbol] ’. The third slide bar 115a includes a third vertical bar protruding vertically from the inner peripheral wall of the housing 110 and a third hook made by bending the end of the third vertical bar to an angle of 90°, and the fourth slide bar 115b includes a fourth vertical bar protruding vertically from the inner peripheral wall of the housing 110 in such a way as to be spaced apart from the third vertical bar by a given distance and a fourth hook made by bending the end of the fourth vertical bar to an angle of 90° in the opposite direction to the third hook.

The third slide bar 115a and the fourth slide bar 115b are spaced apart from each other by the given distance, and accordingly, the space between the third slide bar 115a and the fourth slide bar 115b forms a second slide groove 115c in the longitudinal direction of the housing 110.

As shown in FIGS. 6, 9, 10, and 17, a first cleaning brush 116 having the shape of an arch comes into contact with the inner peripheral wall of the housing 110 and is thus inserted between the first slide bar 114a and the third slide bar 115a in upward and downward directions.

As shown in FIG. 11, the first cleaning brush 116 includes a first core member 116a made of a silicone material so that it is soft and flexible with given elasticity. The first core member 116a has first grooves 116b formed at given intervals on the surface coming into contact with the inner peripheral wall of the housing 110 in a longitudinal direction thereof and a plurality of first bristles 116c protruding from the opposite surface of the first core member 116a to the surface coming into contact with the inner peripheral wall of the housing 110 toward the central portion of the inside of the housing 110.

The formation of the first grooves 116b enables the first core member 116a to be more softly bent to have the shape of the arch, so that the first core member 116a is easily insertedly fitted to the inner peripheral wall of the housing 110.

The first cleaning brush 116 has first stepped projections 116d protruding from both ends thereof in such a way as to extend in upward and downward directions, and the first stepped projections 116d are fitted to the first hook of the first slide bar 114a and the third hook of the third slide bar 115a, come into contact with the inner peripheral wall of the housing 110, and are thus slidingly inserted into the housing 110 in the downward direction above the housing 110.

Like the first cleaning brush 116, a second cleaning brush 117 has a second core member 117a, second grooves 117b, second bristles 117c, and second stepped projections 117d, and the second stepped projections 117d are fitted to the second hook of the second slide bar 114b and the fourth hook of the fourth slide bar 115b, come into contact with the inner peripheral wall of the housing 110, and are thus slidingly inserted into the housing 110 in the downward direction above the housing 110. The second cleaning brush 117 is the substantially same as the first cleaning brush 116 and different in that it is inserted into the opposite side to the inner peripheral wall side of the housing 110 into which the first cleaning brush 116 is inserted, and therefore, an explanation of the second cleaning brush 117 will be not given anymore.

Like this, the first cleaning brush 116 and the second cleaning brush 117 are inserted conveniently into the housing 110, and if necessary, they can be separated from the housing 110 so that the dirt attached to the first cleaning brush 116 and the second cleaning brush 117 or the dirt existing in the housing 110 is removed. If the first cleaning brush 116 and the second cleaning brush 117 fail to exert their functions due to the use for a long period of time, only they are replaced with new ones, which is more economical for a consumer because the portable cleaning device 100 itself is not replaced with new one.

It can also be implemented with one cleaning brush instead of the first and second cleaning brushes 116 and 117.

As shown in FIG. 17, the housing 110 has a first stopper 118a with given width and height extending from the first slide bar 114a to the third slide bar 115a above the circular stepped projection 113 on the inner peripheral wall of the housing 110.

The first stopper 118a has the given width smaller than the width of the circular stepped projection 113, and if the first cleaning brush 116 comes into contact with the inner peripheral wall of the housing 110 and is thus slidingly inserted into the housing 110 in the downward direction above the housing 110, it is seated onto the first stopper 118a and thus prevented from moving anymore.

Like the first stopper 118a, the housing 110 has a second stopper 118b with given width and height extending from the second slide bar 114b to the fourth slide bar 115b above the circular stepped projection 113 on the inner peripheral wall of the housing 110.

The second stopper 118b has the given width smaller than the width of the circular stepped projection 113, and when the second cleaning brush 117 comes into contact with the inner peripheral wall of the housing 110 and is thus slidingly inserted into the housing 110 in the downward direction above the housing 110, it is seated onto the second stopper 118b and thus prevented from moving anymore.

The golf ball seating member 120 is a member coupled to a top of the housing 110 and includes a ring-shaped auxiliary coupling member 130 and a golf ball reciprocating member 140 coupled to the auxiliary coupling member 130.

As shown in FIGS. 6 and 7, the golf ball reciprocating member 140 includes a handle 141 held by the user's hand, a top cap 142 coupled to the underside of the handle 141, and a golf ball seating stand 143 coupled to the underside of the top cap 142 to seat a golf ball 10 thereon.

As shown in FIG. 6, the top cap 142 consists of a first cap member 142a coupled to the handle 141 and having the biggest diameter, a second cap member 142b having a smaller diameter than the first cap member 142a, and a third cap member 142c having a smaller diameter than the second cap member 142b.

The third cap member 142c is configured to allow the central portion of the underside thereof to be coupled to the golf ball seating stand 143 having a given length, and at least one or more rotation and coupling grooves 142d are formed on the side periphery of the third cap member 142c in a longitudinal direction.

Each rotation and coupling groove 142d consists of a vertical groove and a horizontal groove extending horizontally from the vertical groove, so that the vertical insertion and horizontal rotation are coupled to each other through the rotation and coupling groove 142d.

The golf ball seating stand 143 includes a long rod-shaped seating stand body 144 having a seating opening 145 of a given diameter formed on the lower portion thereof, a golf ball pressurizer 146 located on top of the seating opening 145, and a golf ball seating plate 147 located on the bottom of the seating opening 145 to seat the golf ball 10 thereon.

The seating stand body 144 has a pair of protrusions 148 protruding outward from both ends of a bottom thereof. The pair of protrusions 148 is slidingly inserted into the first and second slide grooves 114c and 115c of the housing 110, and if the handle 141 reciprocates up and down, the protrusions 148 reciprocate along the first and second slide grooves 114c and 115c.

The golf ball pressurizer 146 has the shape of a flat circle, and if the handle 141 moves up and down in the state where the golf ball 10 is seated onto the golf ball seating plate 147, the golf ball pressurizer 146 comes into contact with the golf ball 10 and thus pushes down the golf ball 10.

The golf ball seating plate 147 is bigger in size than the golf ball pressurizer 146 and has the shape of a concave circle to allow the golf ball 10 to be placed stably thereon, and if the handle 141 moves up and down, the golf ball seating plate 147 lifts up the golf ball 10.

As shown in FIGS. 12 and 13, the auxiliary coupling member 130 includes a circular body 131 whose central portion is open, a locking projection 132 extending inward from the circular body 131, bent, and then extending downward from the bent portion thereof by a given length, and a first screw thread 133 formed on the inner peripheral wall of the circular body 131 under the locking projection 132.

The auxiliary coupling member 130 further includes a plurality of protrusions 134 protruding from the inner peripheral surface of the locking projection 132 in such a way as to be spaced apart from one another by a given distance.

The first cap member 142a has an opening marker 149a and a closing marker 149b located on the peripheral portion of a top thereof, and the circular body 131 has a position marker 139 located on a top thereof.

If the top cap 142 is inserted vertically downward into the central portion of the circular body 131 in a state where the opening marker 149a is aligned with the position marker 139, the underside of the first cap member 142a is seated onto the top of the locking projection 132, and the protrusions 134 of the auxiliary coupling member 130 are inserted into the rotation and coupling grooves 142d of the third cap member 142c.

If the handle 141 rotates in a direction where the closing marker 149b is aligned with the position marker 139, the handle 141 rotates horizontally again in the state where the protrusions 134 of the circular body 131 are inserted vertically into the rotation and coupling grooves 142d, so that the protrusions 134 are coupled to the rotation and coupling grooves 142d to allow the auxiliary coupling member 130 to be firmly coupled to the top cap 142.

The auxiliary coupling member 130 is fitted to the upper portion of the housing 110 to allow the first screw thread 133 to be fastenedly coupled to the first screw groove 111 of the housing 110.

In the state where the auxiliary coupling member 130 is coupled to the housing 110 and the top cap 142 is coupled to the auxiliary coupling member 130 to allow the closing marker 149b to be aligned with the position marker 139, if the handle 141 rotates and then pulls up to allow the opening marker 149a to move to the position marker 139 and be then aligned with the position marker 139, the protrusions 134 are separated from the rotation and coupling grooves 142d and the golf ball reciprocating member 140 is thus separated from the auxiliary coupling member 130, so that the golf ball reciprocating member 140 is lifted vertically upward through the top opening of the housing 110 and the open portion of the auxiliary coupling member 130.

If the handle 141 is lifted up more, the top cap 142 coupled to the handle 141 is raised more, together with the golf ball seating stand 143, and accordingly, the protrusions 148 of the golf ball seating stand 143 are locked onto the underside of the locking projection 132 of the auxiliary coupling member 130, so that the auxiliary coupling member 130 and the housing 110 are lifted together. If the golf ball seating stand 143 escapes from the top opening of the housing 110 and is exposed to the outside, the golf ball 10 is seated onto top of the golf ball seating plate 147 by means of a user.

According to the conventional golf ball cleaning device, in the state where the handle and the body (housing) are completely separated from each other, the golf ball is put into the body or removed from the body, and if it is desired to remove the golf ball from the body after the golf ball has been cleaned, the body is held by a user's one hand, and the handle by his or her other hand, so that the handle is completely separated from the body. Next, after the body is placed on a floor or flat place, the golf ball is removed from the body by his or her hand holding the body, thereby making his or her both hands required to cause many inconveniences in removing the golf ball from the body. Besides, if the golf ball is removed from the body, while the body is being held by the user's hand because there is no floor or flat place, the body and the golf ball are simultaneously held by the user's one hand, which causes many inconveniences. Of course, such inconveniences may occur even when the golf ball puts into the body of the golf ball cleaning device.

According to the portable golf ball cleaning device 100 of the present disclosure, if it is desired to remove the golf ball from the golf ball seating plate 147, the protrusions 148 are locked onto the underside of the locking projection 132, and even in the state where only the handle 141 is held by the user's one hand, accordingly, the handle 141 and the housing 110 are lifted together, so that the golf ball 10 is easily removed from the golf ball seating plate 147 by the other hand of the user. In the same manner as above, if it is desired to place the golf ball 10 on the golf ball seating plate 147, the handle 141 is held by the user's one hand and the golf ball 10 is easily seated onto the golf ball seating plate 147 by the user's other hand, because the golf ball seating plate 147 and the housing 110 move like a unitary body. Only if the handle 141 is held by the user, therefore, it is not necessary to hold the housing 110, to place the housing 110 on a given location, and to hold the housing 110 together with the golf ball 10, so that the portable golf ball cleaning device 100 according to the present disclosure can be more conveniently used.

If the handle 141 reciprocates up and down after the golf ball 10 has been seated onto the golf ball seating plate 147, the golf ball seating stand 143 is inserted into the housing 110 and moves up and down, and the golf ball 10 seated onto the golf ball seating plate 147 rubs against the first cleaning brush 116 and the second cleaning brush 117 and is thus cleaned, thereby causing the dirt attached to the golf ball 10 to be removed from the surface of the golf ball 10.

As shown in FIGS. 2 and 3, the bottom cap member 150 includes a bottom cap body 151 detachably coupled to the lower portion of the housing 110. The bottom cap body 151 is open on a top thereof and closed on an underside thereof in such a way as to form an internal space portion 152 and has a second screw thread 153 along the inner peripheral wall thereof. Further, the bottom cap body 151 is convex upward from a central portion of the underside thereof.

The bottom cap member 150 is fitted to the lower portion of the housing 110 to allow the second screw thread 153 to be fastenedly coupled to the second screw groove 112 of the housing 110.

As shown in FIGS. 14 to 16, an auxiliary cap member 160 is made of a flexible material such as silicone, rubber, and the like and has a diameter smaller than the housing 110 so that the auxiliary cap member 160 is inserted into the underside opening of the housing 110.

The auxiliary cap member 160 includes a circular auxiliary cap body 161 having a given thickness, a vertical member 162, and locking hooks 163.

The vertical member 162 extends vertically from the auxiliary cap body 161 to a given height and has the shape of a circle along the periphery of the auxiliary cap body 161, while having a smaller diameter than the auxiliary cap body 161,

The locking hooks 163 protrude from one side peripheral surface of the vertical member 162 in such a way as to be spaced apart from one another at given intervals. As the auxiliary cap member 160 is inserted into the underside opening of the housing 110 to allow the locking hooks 163 to be locked onto the circular stepped projection 113 of the housing 110, the auxiliary cap member 160 is fixed to the housing 110.

The auxiliary cap member 160 has a bottom 164 whose diameter becomes small toward a central portion thereof. In detail, the auxiliary cap member 160 is tapered to be slant downward from the peripheral portion thereof toward the central portion thereof. Further, the auxiliary cap member 160 has a through hole 165 formed at the central portion of the bottom 164. The auxiliary cap member 160 defines a top of the internal space portion 152, and it forms the internal space portion 152, together with the bottom cap member 150.

As shown in FIGS. 4 and 5, the central portion of the auxiliary cap member 160 is tapered downward, and the bottom of the bottom cap member 150 is convex upward from the central portion thereof. Therefore, the internal space portion 152 has a height of the central portion thereof lower than a height of the peripheral portion thereof.

If the golf ball 10 is cleaned, the dirt attached to the golf ball 10 is removed from the surface of the golf ball 10 by means of the first cleaning brush 116 and the second cleaning brush 117, and the dirt falls down by means of gravity and is collected on the auxiliary cap member 160, while some of the dirt pass through the through hole 165 and enter the internal space portion 152. If the dirt enters the internal space portion 152, the dirt is pushed toward the peripheral portion of the internal space portion 152 because the bottom of the bottom cap member 150 is convex upward from the central portion thereof. Once the dirt enters the internal space portion 152, however, it is hard that the dirt moves back to the housing 110 by means of the through hole 165 because of the structures of the internal space portion 152 and the through hole 165. That is, it is easy that the dirt enters the internal space portion 152 by means of the through hole 165, but it is hard that the dirt moves back to the housing 110. Therefore, the auxiliary cap member 160 is called a dirt filter or backflow prevention filter, thereby preventing the dirt from moving back to the housing 110.

According to another embodiment of the present disclosure, instead of inserting the auxiliary cap member 160 into the underside opening of the housing 110, the housing 110 is configured to allow the underside thereof to have the same structure as the auxiliary cap member 160.

To allow cleaning to be easily performed, water or a cleaning liquid is put inside the housing 110. To prevent water leakage from occurring, further, the portable golf ball cleaning device 100 according to the present disclosure includes sealing members 101, 102, and 103 on coupling portions between the top cap 142 and the auxiliary coupling member 130, between the upper portion of the housing 110 and the auxiliary coupling member 130, and between the lower portion of the housing 110 and the bottom cap member 150.

To clean the golf ball 10, the auxiliary coupling member 130 is coupled to the housing 110, and in a state where the top cap 142 is open, the golf ball 10 to which dirt is attached is placed on the golf ball seating plate 147. Next, the handle 141 is held to allow the golf ball reciprocating member 140 to reciprocate up and down several times. The dirt attached to the golf ball 10 is removed by means of the friction of the golf ball 10 against the first cleaning brush 116 and the second cleaning brush 117, and the dirt removed from the golf ball 10 passes through the auxiliary cap member 160 and is collected in the internal space portion 152. After that, the cleaned golf ball 10 is out of the golf ball seating plate 147 and then used. If a given amount of dirt is collected in the internal space portion 152, the bottom cap member 150 is separated from the housing 110, and the dirt collected in the internal space portion 152 is removed.

As described above, the portable golf ball cleaning device according to the present disclosure is capable of cleaning the golf ball well even if a given amount of dirt is collected therein and capable of easily removing the dirt collected therein.

While the present disclosure has been described with reference to the particular illustrative embodiments, it is not to be restricted by the embodiments but only by the appended claims. It is to be appreciated that those skilled in the art can change or modify the embodiments without departing from the scope and spirit of the present disclosure.

1. A portable golf ball cleaning device comprising:
a housing having a cleaning member;
a golf ball reciprocating member for receiving and reciprocating a golf ball to allow dirt attached to the surface of the golf ball to be removed by means of the cleaning member; and
a backflow prevention filter for defining an internal space portion formed on an underside of the housing, having a through hole formed on a central portion thereof in such a way as to pass the dirt therethrough, and preventing the dirt collected in the internal space portion from moving back to the housing.

2. The portable golf ball cleaning device according to claim 1, wherein the internal space portion is open to remove the dirt collected therein.

3. The portable golf ball cleaning device according to claim 2, wherein the backflow prevention filter is slant downward from a peripheral portion thereof toward a central portion thereof.

4. The portable golf ball cleaning device according to claim 3, wherein the internal space portion has a bottom convex upward from the central portion thereof.

5. The portable golf ball cleaning device according to claim 1, wherein the internal space portion has a height of the central portion thereof lower than a height of the peripheral portion thereof.

6. The portable golf ball cleaning device according to claim 1, wherein the cleaning member comprises a first cleaning brush and a second cleaning brush detachably attached to the housing in such a way as to come into contact with the inner peripheral wall of the housing and be thus inserted into the housing.

7. The portable golf ball cleaning device according to claim 6, wherein the first and second cleaning brushes each comprises a core member made of a flexible material and having a plurality of grooves in a longitudinal direction thereof and a plurality of bristles protruding from the core member.

8. A portable golf ball cleaning device comprising:
a housing open on a top and underside thereof to form a top opening and an underside opening and a cleaning member located at the inside thereof;
a golf ball reciprocating member having a handle, a top cap coupled to the handle, and a golf ball seating stand coupled to the top cap in such a way as to receive a golf ball; and
a bottom cap member detachably coupled to a lower portion of the housing, while being open on a top thereof and closed on an underside thereof to form an internal space portion therein.

9. The portable golf ball cleaning device according to claim 8, wherein if the handle moves up and down in a state where the golf ball is seated onto the golf ball seating stand, the golf ball is cleaned by means of the cleaning member, and if dirt attached to the surface of the golf ball moves down to the internal space portion, the bottom cap member is separated from the housing to remove the dirt from the internal space portion.

10. The portable golf ball cleaning device according to claim 8, further comprising an auxiliary cap member located on the underside opening of the housing to form the internal space portion, together with the bottom cap member, the auxiliary cap member having a through hole formed on a central portion thereof in such a way as to pass the dirt therethrough.

11. The portable golf ball cleaning device according to claim 10, wherein the auxiliary cap member is slant downward from a peripheral portion thereof toward a central portion thereof.

12. The portable golf ball cleaning device according to claim 11, wherein the bottom cap member has a bottom convex upward from the central portion thereof.

13. The portable golf ball cleaning device according to claim 8, wherein the internal space portion has a height of the central portion thereof lower than a height of the peripheral portion thereof.

14. The portable golf ball cleaning device according to claim 8, wherein the cleaning member comprises a first cleaning brush and a second cleaning brush detachably attached to the housing in such a way as to come into contact with the inner peripheral wall of the housing and be thus inserted into the housing.

15. The portable golf ball cleaning device according to claim 14, wherein the first and second cleaning brushes each comprises a core member made of a flexible material and having a plurality of grooves in a longitudinal direction thereof and a plurality of bristles protruding outward from the core member.

16. The portable golf ball cleaning device according to claim 8, wherein the housing has a stepped projection protruding inward from the inner peripheral wall thereof at the inside of the underside opening thereof and a first fitting member and a second fitting member extending from the inner peripheral wall of the top opening of the housing to the stepped projection in upward and downward directions in such a way as to face each other.

17. The portable golf ball cleaning device according to claim 16, wherein the first fitting member comprises a first slide bar and a second slide bar spaced apart from each other, the first slide bar having a first vertical bar protruding vertically from the inner peripheral wall of the housing and a first hook made by bending the end of the first vertical bar to an angle of 90°, and the second slide bar having a second vertical bar protruding vertically from the inner peripheral wall of the housing and a second hook made by bending the end of the first vertical bar to an angle of 90° in the opposite direction to the first hook, and the second fitting member comprises a third slide bar and a fourth slide bar spaced apart from each other, the third slide bar having a third vertical bar protruding vertically from the inner peripheral wall of the housing and a third hook made by bending the end of the third vertical bar to an angle of 90°, and the fourth slide bar having a fourth vertical bar protruding vertically from the inner peripheral wall of the housing and a fourth hook made by bending the end of the fourth vertical bar to an angle of 90° in the opposite direction to the third hook.

18. The portable golf ball cleaning device according to claim 17, wherein the cleaning member comprises a first cleaning brush to come into contact with the inner peripheral wall of the housing in such a way as to be detachably fitted between the first slide bar and the third slide bar in upward and downward directions, and a second cleaning brush to come into contact with the inner peripheral wall of the housing in such a way as to be detachably fitted between the second slide bar and the fourth slide bar in upward and downward directions.

19. The portable golf ball cleaning device according to claim 8, further comprising an auxiliary coupling member coupled to the housing and having a locking projection and first protrusions, wherein the golf ball reciprocating member has rotation and coupling grooves formed on the top cap in such a way as to be coupled to the first protrusions so that the golf ball reciprocating member is coupled to the auxiliary coupling member, and the golf ball seating stand has second protrusions protruding outward from both ends of a lower portion thereof in such a way as to be locked onto the locking projection so that the golf ball seating stand is prevented from escaping from the auxiliary coupling member.
